(19) United States
(12) Patent Application Publication
(10) Pub. No.: US 2020/0347642 A1
(43) Pub. Date: Nov. 5, 2020

(54) LOCK WITH KEY STORAGE ROOM

(71) Applicant: YAO-KUN YANG, Taichung City (TW)

(72) Inventor: YAO-KUN YANG, Taichung City (TW)

(21) Appl. No.: 16/398,291

(22) Filed: Apr. 30, 2019

(51) Int. Cl. E05B 37/02; E05B 19/00; E05B 17/10

(52) U.S. Cl. CPC E05B 37/025; E05B 17/10; E05B 19/0005

(57) ABSTRACT

A lock assembly includes a box composed of two parts, and a room is defined between the two parts. Keys and key chains are stored in the room. A number wheel unit is connected to the box and includes multiple number wheels partially exposed beyond the box for convenience of operation. A shackle unit is connected to the box so as to lock or unlock the lock assembly. A light-emitting unit is located within the room and powered by a power source. The light-emitting unit illuminates the number wheels of the number wheel unit for convenience of operating the number wheels at night. The two parts can be opened to access the keys and the key chains by operating the number wheels correctly.

### BACKGROUND OF THE INVENTION

### 1. Fields of the Invention

The present invention relates to a lock, and more particularly, to a paddle lock with a room for receiving keys therein.

### 2. Descriptions of Related Art

The conventional locks such as locks for garages, gates, storage cabinets, or the like, are cooperated with a key so that the users can lock the storage cabinets (for example) and leave. However, the users have to carry the keys with them which may be heavy and occupy a lot of space.

Some locks are combination locks with are required to input correct combination to unlock the locks. Usually, there are multiple umber pads or number wheels so that the users can input the correction combination. Nevertheless, these number pads or number wheels are tiny and cannot be seen clearly at night, and this is inconvenient for the users.

The present invention intends to provide a lock with a storage room therein so that the keys of the lock can be stored in the room, and a light emitting unit is provided to illuminate the number pads or number wheels.

### SUMMARY OF THE INVENTION

The present invention relates to a lock assembly and comprises a box having a first part and a second part which is pivotably mounted to the first part to define a room between the first and second parts. A number wheel unit is connected to the first part or the second part, and the number wheel unit includes multiple number wheels which are partially extending through slots defined through the wall of the first part or the second part. Each number wheel is semi-transparent wheel. A resilient member is located on one side of the number wheel unit.

A shackle unit is connected to one of the first and second parts that is not connected with the number wheel unit. The shackle unit includes a locking member and a U-shaped shackle which includes a first end and a second end. The first end of the U-shaped shackle is pivotally connected to the one of the first and second parts that is not: connected with the number wheel unit, and the second end of the U-shaped shackle is detachably engaged with the locking member. The locking member is shifted to release the second end of the U-shaped shackle from the locking member. An engaging member is connected to the one of the first and second parts that is not connected with the number wheel unit, and the engaging member is engaged with the resilient member when the first and second parts are mounted to each other.

A light-emitting unit is located beside the number wheel unit and located within the morn. The light-emitting unit includes a transparent cover, a power source and a light-emitting member. The power source is accommodated in the transparent cover, and the light-emitting member is connected to transparent cover and located corresponding to the number wheel unit. The light-emitting member is electrically connected to the power source so as to illuminate the number wheels and the room.

The present invention will become more apparent from the following description, when taken in connection with the accompanying drawings which show, for purposes of illustration only, a preferred embodiment in accordance with the present invention.

### BRIEF DESCRIPTION OF THE DRAWINGS

FIG. 1 is a perspective view to show the lock assembly of the present invention;

FIG. 2 is a perspective view to show that the first and second parts of the lock assembly of the present invention are opened;

FIG. 3 shows that the light-emitting unit illuminates the number wheels of the number wheel unit;

FIG. 4 shows that the number wheels of the number wheel unit are illuminated when seen from outside of the lock assembly of the present invention;

FIG. 5 shows that the at least one positioning member in the room is a magnet to which a key is magnetically attracted, and

FIG. 6 shows that the at least one positioning member in the room is a hook to which a key is hooked.

### DETAILED DESCRIPTION OF THE PREFERRED EMBODIMENT

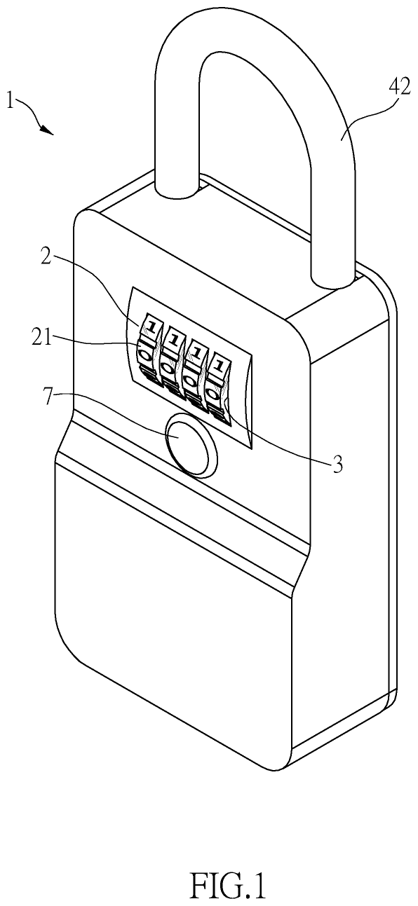

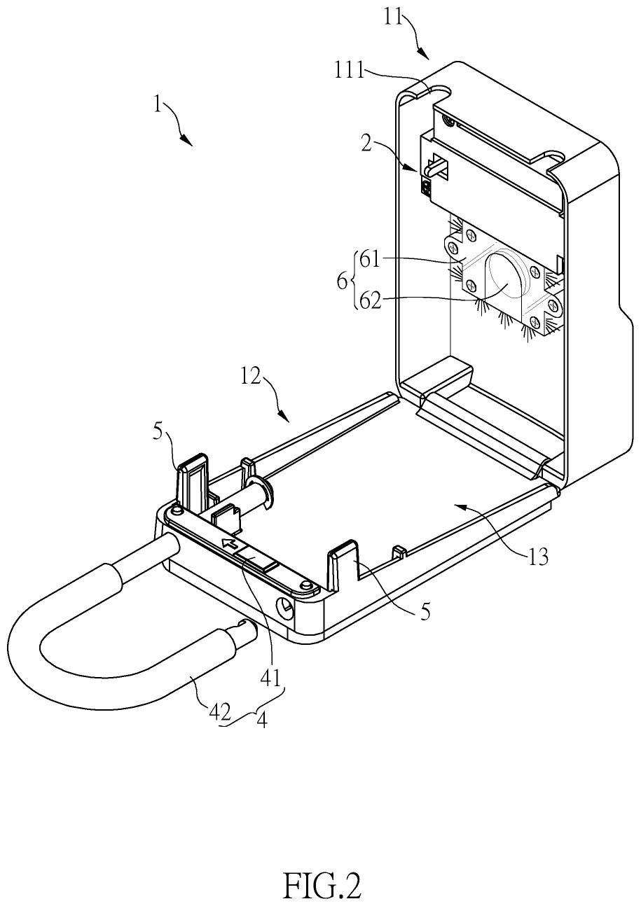

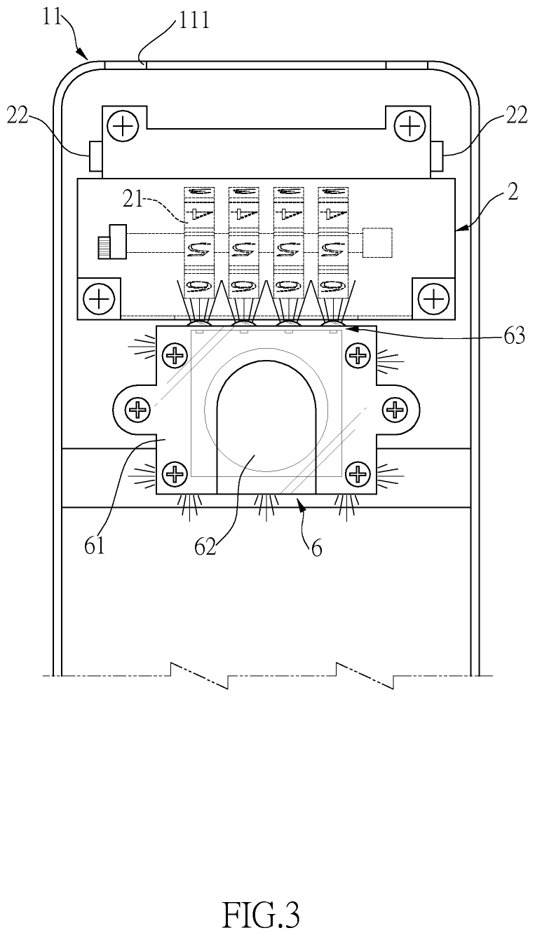

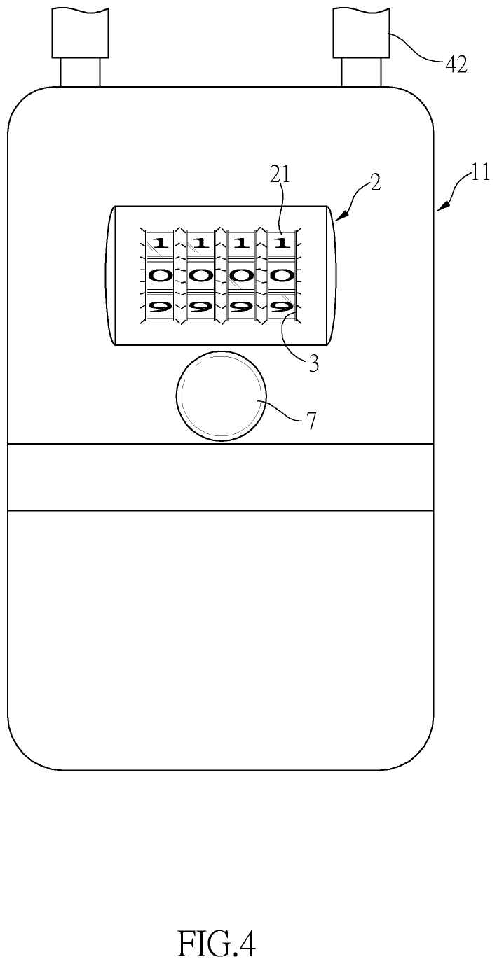

Referring to FIGS. 1 to 6, the lock assembly and comprises a box 1 which is composed or a first part 11 and a second part 12 which is pivotably mounted to the first part 11 to define a room 13 between the first and second parts 11, 12.

A number wheel unit 2 is connected to the first part 11, and the number wheel unit 2 includes multiple number wheels 21 which are partially extending through slots 3 defined through the wall of the first part 11. Each number wheel 21 is semi-transparent wheel which allows light to be refracted. A resilient member 22 is located on one side of the number wheel unit 2.

A shackle unit 4 is connected to the second part 12 and includes a locking member 41 and a U-shaped shackle 42 which includes a first end and a second end. The first end of the U-shaped shackle 42 is pivotably connected to the one of the second part 12, and the second end of the U-shaped shackle 42 is detachably engaged with the locking member 41. The locking member 41 is shifted to release the second end of the U-shaped shackle 42 from the locking member 41 as any conventional lock. An engaging member 5 is connected to the second part 12, and the engaging member 5 is engaged with the resilient member 22 when the first and second parts 11, 12 are mounted to each other. Specifically, two notches 111 are defined in one side panel of the first part 11 so that the U-shaped shackle 42 are accommodated win the two notches 111 when the first and second parts 11, 12 are mounted to each other.

A light-emitting unit 6 is located beside the number wheel unit 2 and located within the room 13. The light-emitting unit 6 includes a transparent cover 61, a power source 52 and a light-emitting member 63. The transparent cover 61 is connected to an inside of the first part 11. The power source 52 is accommodated in the transparent cover 61, and the light-emitting member 63 is connected to transparent cover 61 and located corresponding to the number wheel unit 2. The light-emitting member 63 is, electrically connected to the power source 52 so as to illuminate the number wheels 21 and the room 13. The box 1 includes a switch 7 connected to the outside thereof. The switch 7 is located corresponding to the light-emitting unit 6 and electrically connected to the power source 62 so as to control electric connection bet the power source 62 and the light-emitting member 63.

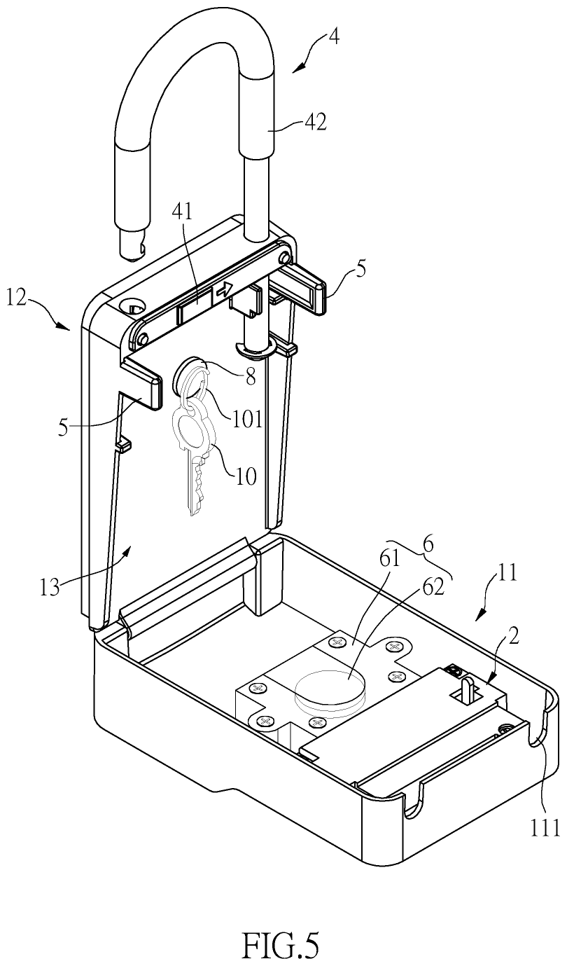

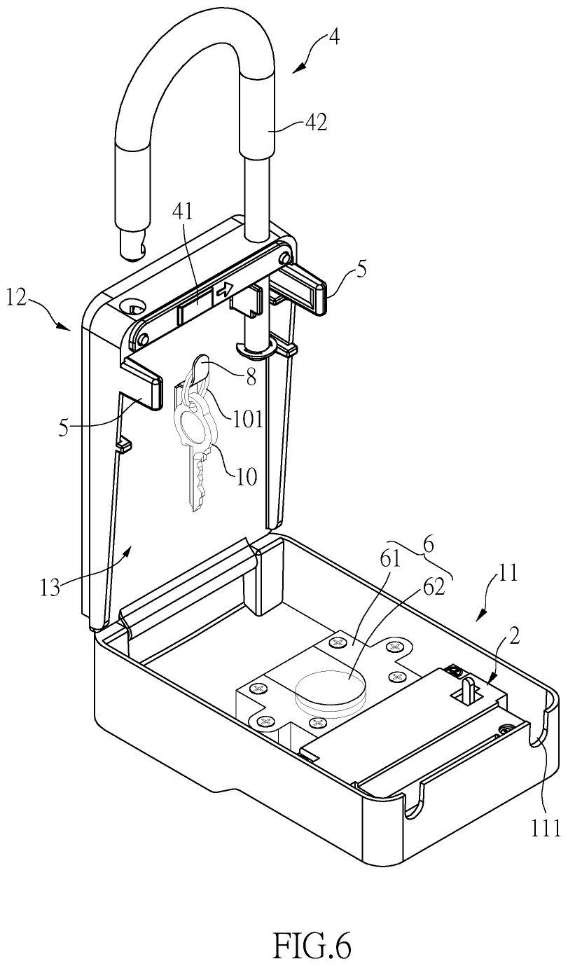

As shown in FIGS. 5 and 6, at least one positioning member 8 is connected to the one of the second part 12 so as to position a key 10. The at least one positioning member 8 can be a magnet as shown in FIG. 5 so as to magnetically attract a key 10 thereto. The at least one positioning member 8 can also be a hook such that a key chain 101 can be hooked with the hook.

When in use, the user shifts the locking member 41 to unlock the U-shaped shackle 42 so that the second end of the U-shaped shackle 42 pops out from the second part 12 so that the user uses the U-shaped shackle 42 to lock the storage cabinet for example by pushing the second end of the V-shaped shackle 42 toward the second part 12 again until the U-shaped shackle is locked with the locking member 41. Then the user pivots the first and second parts 11, 12 away from each other, and the key 10 is put in the room 13 by using the at least one positioning member 8. The first and second parts 11, 12 are then closed to each other by engaging the engaging member 5 with the resilient member 22. Therefore, the user does not need to carry the key 10 with him/her.

By input correct combination via the number wheels 21, the first and second part 11, 12 can be opened, so that the key 10 can be picked to unlock the U-shaped shackle 42 of the lock assembly. The number wheels 21 can be seen clearly by pushing the switch 7 to allow the light-emitting unit 6 to illuminate the number wheels 21. The light-emitting unit 6 also to illuminate the interior of the room 13 to let the user to pick the correct key 10 if there are multiple keys stored in the room 13.

While we have shown and described the embodiment in accordance with the present invention, it should be clear to those skilled in the art that further embodiments may be made without departing from the scope of the present invention.

What is claimed is:

1. A lock assembly comprising:
a box having a first part and a second part which is pivotably mounted to the first part to define a room between the first and second parts;
a number wheel unit connected to the first part or the second part, the number wheel unit including multiple number wheels which are partially extending through slots defined through a wall of the first part or the second part, each number wheel being semi-transparent wheel, a resilient member located on one side of the number wheel unit;
a shackle unit connected to one of the first and second parts that is not connected with the number wheel unit, the shackle unit including a locking member and a U-shaped shackle which includes a first end and a second end, the first end of the U-shaped shackle pivotably connected to the one of the first and second parts that is not connected with the number wheel unit, the second end of the U-shaped shackle detachably engaged with the locking member, the locking member being shifted to release the second end of the U-shaped shackle from the locking member, an engaging member connected to the one of the first and second parts that is not connected with the number wheel unit, the engaging member engaged with the resilient member when the first and second parts are mounted to each other, and
a light-emitting unit located beside the number wheel unit and located within the room, the light-emitting unit including a transparent cover, a power source and a light-emitting member, the power source accommodated in the transparent cover, the light-emitting member connected to transparent cover and located corresponding to the number wheel unit, the light-emitting member electrically connected to the power source so as to illuminate the number wheels and the room.

2. The lock assembly as claimed in claim 1, wherein the box includes a switch connected to an outside thereof, the switch is located corresponding, to the light-emitting unit and electrically connected to the power source so as to con trol electric connection between the power source and the light-emitting member.

3. The lock assembly as claimed in claim 1, wherein two notches defined in one of side panels of the first part or the second part that has the number wheel unit connected thereto, the U-shaped shackle are accommodated win the two notches when the first and second parts are mounted to each other.

4. The lock assembly as claimed in claim 2, wherein two notches defined in one of side panels of the first part or the second part that has the number wheel connected thereto, the U-shaped shackle are accommodated win the two notches when the first and second parts are mounted to each other.

5. The lock assembly as claimed in claim 1, where in at least one positioning member is connected to the one of the first and second parts that is not connected with the number wheel unit, the at least one positioning member is adapted to position a key.

6. The lock assembly as claimed in claim 5, wherein the at least one positioning member is a magnet.

7. The lock assembly as claimed in claim 5, wherein the at least one positioning member is a hook.
